(19) United States
(12) Patent Application Publication
(10) Pub. No.: US 2025/0102303 A1
(43) Pub. Date: Mar. 27, 2025

(54) DUAL FUNCTION GYRO AND ACCELEROMETER WITH SINGLE MAGNETICALLY LEVITATED PROOF MASS

(71) Applicant: The Charles Stark Draper Laboratory, Inc., Cambridge, MA (US)

(72) Inventor: Andrew Cunningham, Cambridge, MA (US)

(21) Appl. No.: 18/897,819

(22) Filed: Sep. 26, 2024

Related U.S. Application Data
(60) Provisional application No. 63/585,290, filed on Sep. 26, 2023.

(51) Int. Cl. G01C 19/72

(52) U.S. Cl. CPC G01C 19/722

(57) ABSTRACT

An instrument for detecting a position in space may include a proof mass arranged along an input axis, an electromagnetic coil arranged at each end of the proof mass and configured to suspend the proof mass therebetween, wherein the proof mass is configured to rotate along the input axis, and at least one rotation sensor configured to detect the rotational position of the proof mass.

### CROSS-REFERENCE TO RELATED APPLICATIONS

This application claims the benefit of U.S. provisional application Ser. No. 63/585,290 filed Sep. 26, 2023, the disclosure of which is hereby incorporated in its entirety by reference herein.

### TECHNICAL FIELD

Aspects of the disclosure generally relate to systems and methods for duel function gyro and accelerometers with single magnetically levitated proof mass.

### BACKGROUND

Certain inertial navigation in large vehicles or projectiles, such as missile systems, submarines, aircrafts, and other systems, require high accuracy accelerometers and gyroscopes on each axis. This allows the vehicle to determine its position in space. However, achieving this task can often be costly, require frequent calibration, as well as require up to six independent instruments, such as three each of gyroscopes and accelerometers.

### SUMMARY

An instrument for detecting a position in space may include a proof mass arranged along an input axis, an electromagnetic coil arranged at each end of the proof mass and configured to suspend the proof mass therebetween, wherein the proof mass is configured to rotate along the input axis and at least one rotation sensor configured to detect the rotation position of the proof mass.

A method for detecting a position in space, may include instructing power to supply a pair of coils arranged at each end of a proof mass arranged along an input axis, receiving rotation data from a rotation sensor arranged on the proof mass, determining a location in space based on the rotation data.

An instrument for detecting a position in space, may include a proof mass arranged along an input axis, an electromagnetic coil arranged at each end of the proof mass and configured to suspend the proof mass therebetween, wherein the proof mass is configured to rotate along the input axis, at least one rotation sensor configured to detect the rotational position of the proof mass, and a processor configured to determine a position in space based on the rotation position of the proof mass.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective exploded view of a measurement instrument according to one embodiment.

FIG. 2 illustrates a block diagram of the measurement instrument of FIG. 1.

FIG. 3 illustrates a block diagram of a sample controller for the control loop configured to operate the components of the instrument of FIG. 1.

FIG. 4 illustrates an example process for determining a position in space.

FIG. 5 illustrates an example process for adjusting the current to the coils in order to maintain tension between the proof mass and the coils in a resting state.

FIG. 6 illustrates a side view of the instrument, where the forces are vertical (i.e., the input axis A is up) and the proof mass is in tension between the coils.

FIG. 7 illustrates a top view of an optical feedback system for the instrument.

FIG. 8 illustrates an isometric view of the instrument with the optical feedback system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Certain inertial navigation in large vehicles or projectiles, such as missile systems, submarines, aircrafts, and other systems, require high accuracy accelerometers and gyroscopes on each axis. This allows the vehicle to determine its position in space. However, achieving this task can often be costly, require frequent calibration, as well as require up to six independent instruments, such as three each of gyroscopes and accelerometers.

Existing options may include electromechanical instruments, optical instruments, and MEMs instruments. Electromechanical instruments may allow for a higher accuracy while meeting radiation and environmental requirements. Examples may include mechanical wheel gyroscopes, pendulous integrated gyroscopic accelerometers (PIGAs), etc. These systems, however, can be extremely complex, expensive to manufacture, and highly susceptible to thermal fluctuations.

Optical instruments, including fiber optic gyroscopes and similar devices, may have advantages over such electromechanical instruments at least because such optical instruments allow for a high degree of accuracy and provide an excellent solid state solution. However, optical instruments are typically only used as gyroscopes, and may require very high end fiberoptic coils and loose data during radiation events.

MEMs (Micro-electromechanical Systems) instruments, such as tuning fork gyroscopes, have a small SWaP (size, weight, power), but are often limited in range and performance. MEMs instruments rely on resonators to function, and thus can also drop data during radiation events. MEMs accelerometers may also require a large upfront investment to tailor for a particular application. In general, these are appropriate for high volume and lower accuracy environments, but not all systems.

Disclosed herein is a solid-state approach and instrument that reduces the total number of instruments required while maintaining a high degree of linearity, accuracy, and radiation tolerance. The instrument may be constructed with a magnetically levitating proof mass arranged between two coils. A gyroscope and accelerometer may be combined into a single instrument with a shared proof mass. A control loop may keep the proof mass at a fixed distance from each coil, independently, and keep the proof mass under tension. As such, friction is eliminated as well as many known error terms of inertial sensors. Such instrument may have many applications an benefits, such as underwater autonomous vehicles, hypersonic vehicles, ground or field sensor application, etc.

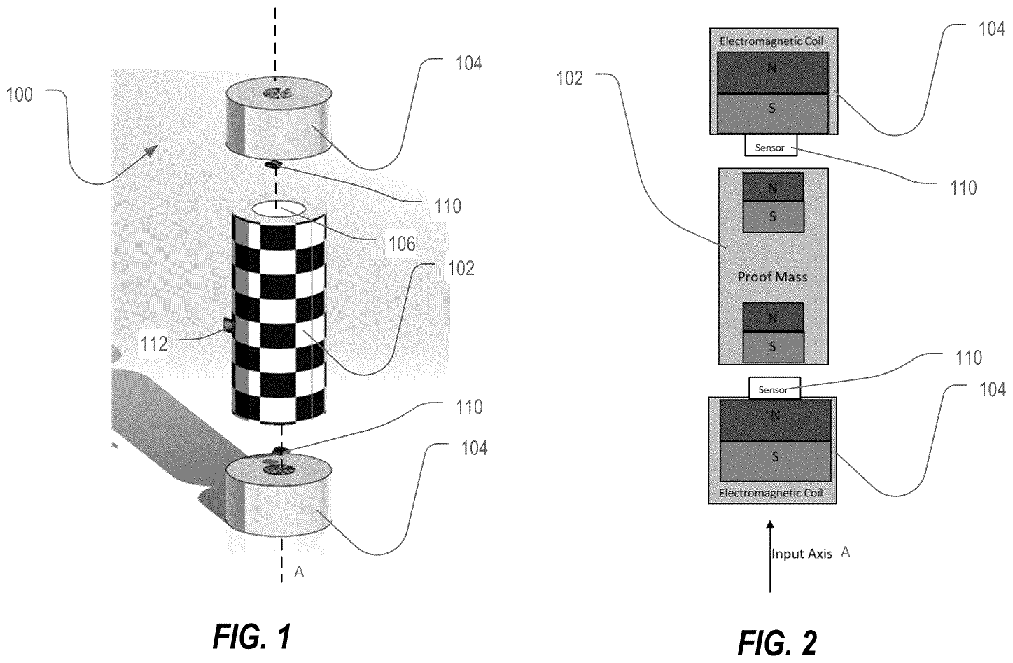

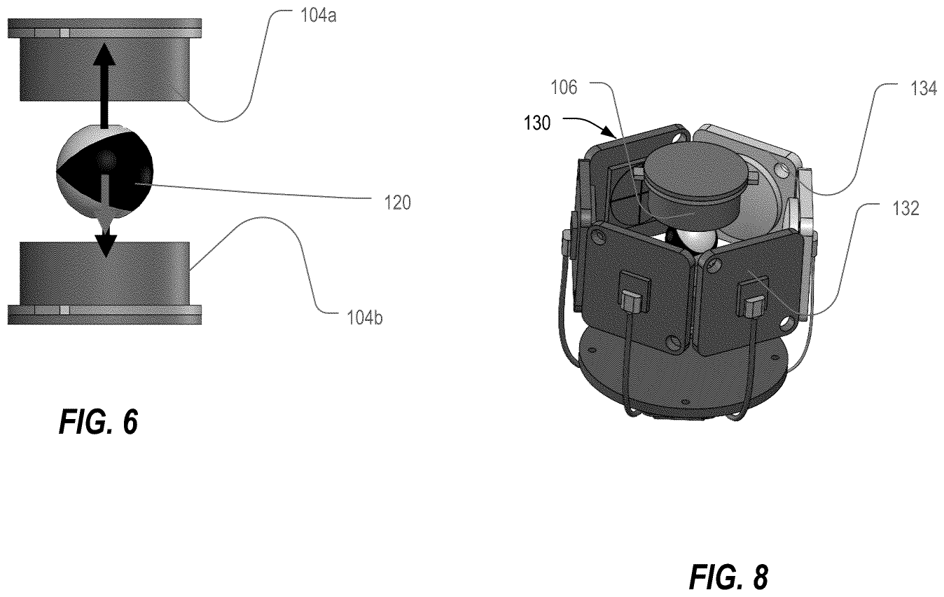

FIG. 1 illustrates a perspective exploded view of a measurement instrument 100 according to one embodiment. The instrument 100 may include a proof mass 102 extending along an input axis A. While the proof mass 102 is illustrated as having a cylindrical shape, other dimensions and shapes may be appreciated. For example, as shown in FIGS. 6-8, the proof mass 102 may have a cylindrical shape.

The proof mass 102 is a mass within a sensor such as an accelerometer, gyroscope, or other inertial measurement device. The proof mass 102 converts mechanical motion into a measurable electronic signal. The movement of the proof mass 102 within the instrument 100 along the axis A is measured to determine a magnitude of force.

The proof mass 102 may be a capacitive proof mass, where movement of the mass 102 changes the capacitance between two plates. In another example, the mass 102 may be piezoelectric, where movement or force on the mass 102 charges a piezoelectric material. An optical mass may use light to detect the displacement of the mass 102. Various sizes and materials may be contemplated for the proof mass 102.

The proof mass 102 may be arranged between a pair of electromagnetic coils 104. The coils 104 may be of a same or similar diameter as that of the proof mass 102 and may be arranged at each end of the proof mass 102. The strength of the coils 104 may be controlled via the position control loop. A permanent magnet 106 may be arranged between the coil 104 and the proof mass 102 to attract the coil 104 to the end of the proof mass 102. The magnet 106 may generate a magnetic field and may be one of many types of permanent magnets 106 such as Neodymium, Samarium Cobalt, Alnico, Ferrite, etc.

A distance sensor 110 may also be arranged between each of the coils 104 and the proof mass 102. The distance sensor 110 may be any number of distance sensors, and may measure its distance from the proof mass 102. In one example, the distance sensor 110 may be a light time-of-flight (ToF), ultrasonic time-of-flight, IR angle, Laser (LiDAR), capacitive or Haul Effect.

A rotation sensor 112 or rotary encoder or angular position sensor may be arranged on the proof mass 102. In the example shown, the rotation sensor 112 is arranged on an external surface of the proof mass 102. This sensor 112 may provide a position read out of the proof mass's rotation, angular position, or angular velocity. Various types of rotation sensors may be used, including rotary encoders, potentiometers, gyroscopes, inertial measurement unites (IMUs), hall effect sensors, resolvers, etc. In one example, the rotation sensor 112 may include a color or optical intensity sensor. The optical intensity sensor may measure the color intensity of light in a given environment. The color sensor detects a specific wavelength of light to determine color of an object or light source. The color sensor may use signal processing and filters to determine the objects color or color of the light source. In another example, magnetic sensors or hall effect sensors may be used in conjunction with magnets installed on the sides of the proof mass 102.

In operation, the proof mass 102 may move freely in space. A force, controlled via a control loop, is applied via the coils 104 and forms the baseline for the measurement. The proof mass 102 may have an exterior surface that allows an external sensor (e.g., rotation sensor 112) to measure its angular position, such as the rotation sensor 112. Various electronics may provide power to the instrument 100, set up the control loop, and convert sensor readouts to digital format. Further, a Ferris material may provide shielding from instrument cross-talk and other environmental fields. In some examples a vacuum may be included to provide optimal performance. This is described in more detail below.

FIG. 2 illustrates a block diagram of the measurement instrument 100 of FIG. 1. The instrument 100 forms a closed loop control of the current in each coil 104. This is controlled, at least in part, with feedback from the corresponding distance sensor 110. When the instrument 100 is in a resting state, the distance from the proof mass 102 is maintained and the proof mass 102 is in tension.

During movement, the control loop applies current to the coils 104. The proof mass 102 is suspended with zero friction between the coils 104. The current applied to the coils 104 is proportional to the acceleration along the input access A of the instrument 100. In some examples, a current pickoff resistor is included and is used. This may allow for higher accuracy and lower noise when converting an analog signal to the digital domain. The rotation sensor 112 detects the absolute rotational position. As explained above, this may be done optically or magnetically. This rotation sensor 112 may function as an encoder and be used for the absolute angular position or relative angular rate.

Performance may be further increased by spinning up the proof mass 102 magnetically around the input access A at instrument startup, which would offset errors induced by imperfect proof mass balance.

In the event of a radiation event, this control loop can drop out for the time it takes for the proof mass 102 to hit the rails, and the instrument 100 would store inertial position by proof mass location similar to a PIGA float.

$$Forces ( IA Up ) : {F}_{coil 1} = {F}_{coil 2} + {F}_{accel} \\ Control Loop Goal : {D}_{1} = {D}_{2}$$

Acceleration can be measured by accurately reading the current in each coil, and subtracting them. If the instrument input axis A is horizontal the current needed to support the proof mass 102 is non-zero, but the difference between the two coils is zero, and the instrument 100 would read 0 G. If the instrument 100 is placed with the input axis A vertical, the top coil 104 would have more current and the instrument would read 1G. This system is capable of canceling out many error terms between the coils. If the proof mass 102 is suspended in a vacuum, the sensor output would be highly linear.

The proof mass 102 is frictionless with no bias force around the input axis A. If the mass 102 is balanced around the input axis A, it can provide an absolute angular position reference. This can be measured using an optical sensor and converted to angular rate, similar to an optical encoder. In the event of a radiation event, the known angular position will not be affected during a drop out provided the vehicle has not made a full rotation.

This instrument 100 is capable of operating through most shock and vibrations environments while power is available to keep the proof mass 102 in place, and the control loop is operational. In the event that a shock exceeds these parameters and the proof mass 102 touches the external walls, position information may be lost temporarily. However, the instrument 100 will survive, recover and be able to operate after the event. While this instrument 100 may be susceptible to localized EMI (i.e., within an IMU) external EMI threats that are consistent across the IMU would affect each coil and magnetic pole equally, and thus be canceled out. Disproportionate, higher frequency noise that would affect performance can be mitigated by shielding the instrument with a ferrous housing.

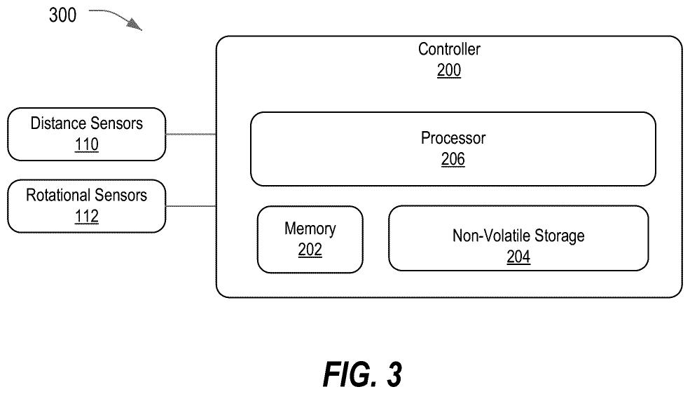

FIG. 3 illustrates a block diagram of a sample controller 300 for the control loop configured to operate the components of the instrument 100. The controller 300 may include a memory 302, a non-volatile storage 304, and a processor 306. The memory 302 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 302 may include one or more persistent data storage devices such as a hard drive, optical drive, tape drive, non-volatile solid-state device, cloud storage or any other device capable of persistently storing information.

The processor 306 may include one or more microprocessors, micro-controllers, digital signal processors, microcomputers, central processing units (CPU), graphical processing units (GPU), tensor processing units (TPU), field programmable gate arrays, programmable logic devices, state machines, logic circuits, analog circuits, digital circuits, or any other devices that manipulate signals (analog or digital) based on computer-executable instructions residing in memory 302.

The processor 306 may be configured to read into memory 302 and execute computer-executable instructions residing in the non-volatile storage 304. Upon execution by the processor 306, the computer-executable instructions may cause the instrument 100 to implement one or more of the algorithms and/or methodologies disclosed herein.

The controller 300 may be electrically connected to the signaling interface of the components of the instrument 100 such as the distance sensors 110 and the rotation sensor 112. For example, the controller 300 may be configured to receive data and readings from the distance sensors 110 and the rotation sensor 112. The controller 300 may use such data to instruct and drive the coils 104 to maintain the proof mass 102 under tension in a resting position, as well as determining the position of the instrument 100 based on the rotation sensor output. The controller 300 may output position information to an external source. By keeping the proof mass 102 in tension between the coils 104, the proof mass 102 is stable when accelerated in any direction and thus, allows for an accurate sensor readout. This is described in more detail with respect to FIG. 6.

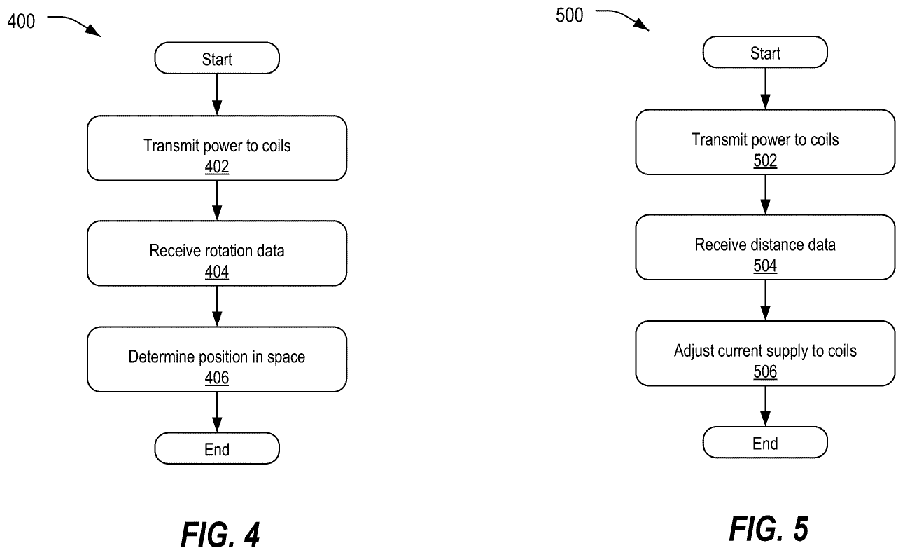

FIG. 4 illustrates an example process 400 for determining a position in space. The process 400 begins at block 402 where the processor 306 instructs current to power the coils 104 arranged at each end of the proof mass 102. At block 404 the processor 306 receives rotation data from the rotation sensor 112. At block 406, the processor 306 then determines the position in space based on the rotation data. The process may then end.

FIG. 5 illustrates an example process 500 for adjusting the current to the coils in order to maintain tension between the proof mass 102 and the coils 104 in a resting state. The process 500 begins at block 502 where the processor 306 instructs current to power the coils 104 arranged at each end of the proof mass 102. At block 504, the processor 306 receives distance data from distance sensors 110 arranged between each coil 104 of the pair of coils and the respective ends of the proof mass 102. At block 506, the processor 306 then adjusts the current supplied to the coils 104 based on the distance to ensure that the proof mass 102 is maintained under tension between the coils 104 in the resting position. The process may then end. Notably, in some examples, the processes 400 and 500 may be combined.

FIG. 6 illustrates a side view of the instrument 100, where the forces are vertical (i.e., the input axis A is up) and the proof mass 102 is in tension between the coils 104. The force keeping the proof mass 102 levitating is applied to the top magnet by the top coil 104a, while the bottom coil 104b provides a smaller opposing force for stability. This provides an extremely high accuracy way to measure acceleration by measuring the current in each coil 104, where the difference between the current in the top coil and the bottom coil provides the acceleration along the input axis A independent of the control loop.

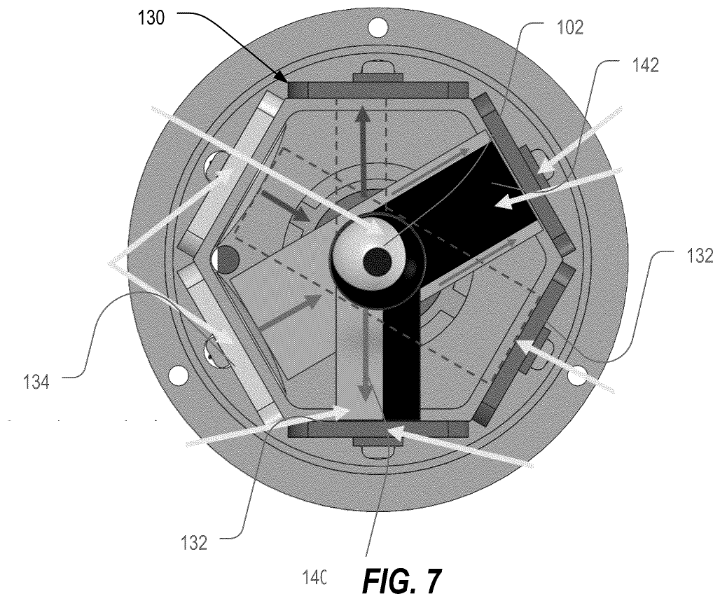

FIG. 7 illustrates a top view of an optical feedback system 130 for the instrument 100. FIG. 8 illustrates an isometric view of the instrument 100 with the optical feedback system 130. The optical feedback system 130 may be at least part of the rotation sensor 112 or may be a standalone system 130. The optical feedback system 130 may aid in the control loop positioning of the proof mass, while providing the absolute angular position of the proof mass as a sensor output. As explained, the displacement of the proof mass 102 can be detected based in its obstruction of light from a light source to the opposing sensor, while it's absolute rotational position can be detected based on reflection to a separate sensor.

The feedback system 130 may include a plurality of photo sensitive diodes 132 arranged around the perimeter of the proof mass 102. The diodes 132 may provide an angle readout as well as a displacement readout. These redouts may be part of the rotation data discussed with respect to FIG. 4 and above. At least two light sources 134 are arranged at the perimeter of the proof mass 102. In the example shown in FIGS. 7 and 8, the diodes 132 include two light sources 134 arranged between four diodes 132. Other configurations and arrangements could be appreciated. The light sources 134 may project light to the proof mass 102. The proof mass 102 may form a sphere and have an external surface formed of reflective material. The proof mass 102 may create reflective light 140 that is received at at least one of the diodes 132. The diodes 132 may receive this reflection and log an angle readout indicating the angle at which the reflection is received at the diode 132.

The proof mass 102 and the light sources 134 may also create a shadow 140 where the proof mass 102 blocks the light. In this situation, the diode 132 at the shadow 140 may provide a displacement readout. The readouts may be received and processed by the controller 300 to determine the placement of the proof mass 102.

The system 130 may also include multiple readouts or multiple wavelengths in order to differentiate between the reflections and shadows. For example, the light sources 134 may each emit light at a specific wavelength, and in turn any reflections of those wavelengths would correspond to the light source. For example, one of the light sources 134 may emit light at a first wavelength and the other may emit light at a second wavelength. Because of this, the system 130 is capable of differential measurements. Further, as shown in FIG. 7, partial shadow and reflection may be received at a diode 132. The controller 300 may then use the readouts to determine the instrument's location.

Accordingly, a magnetically levitating a proof mass between two coils is descried as an instrument to determine a position in space. A control loop keeps the proof mass at a fixed distance from each coil independently, and keeps the proof mass under tension in a resting position.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C #, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An instrument for detecting a position in space, comprising:
a proof mass arranged along an input axis;
an electromagnetic coil arranged at each end of the proof mass and configured to suspend the proof mass therebetween, wherein the proof mass is configured to rotate along the input axis; and
at least one rotation sensor configured to detect the rotation position of the proof mass.

2. The instrument of claim 1, further comprising a distance sensor arranged between each coil and the proof mass to detect a distance between the distance sensor and the proof mass.

3. The instrument of claim 2, further comprising a processor programmed to receive the distance from the distance sensor and instruct current be provided to the coils based on the respective distance to maintain a fixed distances between the proof mass and each coil.

4. The instrument of claim 3, wherein the processor is further programmed to determine a position in space based on the rotational position of the proof mass.

5. The instrument of claim 1, wherein the proof mass has a cylindrical shape.

6. The instrument of claim 1, wherein the proof mass has a spherical shape.

7. The instrument of claim 1, wherein the rotation sensor is arranged on an external surface of the proof mass.

8. The instrument of claim 1, wherein the rotation sensor includes at least one photo sensitive diode configured to receive a light reflection from the proof mass generated by at least one light source.

9. The instrument of claim 8, wherein the at least one light source includes two light sources, each configured to emit different wavelengths to differentiate reflections from each.

10. A method for detecting a position in space, comprising:
instructing power to supply a pair of coils arranged at each end of a proof mass arranged along an input axis;
receiving rotation data from a rotation sensor arranged on the proof mass;
determining a location in space based on the rotation data.

11. The method of claim 10, wherein the power supplied to the coils is proportional to the acceleration of the proof mass along an input access.

12. The method of claim 10, further comprising receiving distance data from a distance sensor arranged between each coil of the pair of coils and respective ends of the proof mass.

13. The method of claim 12, further comprising adjusting the power supply to the coil to maintain the proof mass under tension between the coils in a resting position.

14. An instrument for detecting a position in space, comprising:
a proof mass arranged along an input axis;
an electromagnetic coil arranged at each end of the proof mass and configured to suspend the proof mass therebetween, wherein the proof mass is configured to rotate along the input axis;
at least one rotation sensor configured to detect the rotational position of the proof mass; and
a processor configured to determine a position in space based on the rotation position of the proof mass.

15. The instrument of claim 14, further comprising a distance sensor arranged between each coil and the proof mass to detect a distance between the distance sensor and the proof mass.

16. The instrument of claim 15, wherein the processor is further programmed to receive the distance from the distance sensor and instruct current be provided to the coils based on the respective distance to maintain a fixed distances between the proof mass and each coil.

17. The instrument of claim 3, wherein the proof mass has a cylindrical shape and the electromagnetic coil arranged at each end of the proof mass have a same diameter as that of the proof mass.

18. The instrument of claim 14, wherein the rotation sensor is arranged on an external surface of the proof mass.

19. The instrument of claim 14, wherein the rotation sensor is an optical sensor.

20. The instrument of claim 14, wherein the rotation sensor is a rotary encoder.
